(19) United States
(12) Patent Application Publication
(10) Pub. No.: US 2002/0078358 A1
(43) Pub. Date: Jun. 20, 2002

(54) Electronic voting system

(76) Inventors: C. Andrew Neff, Bellevue, WA (US); James M. Adler, Redmond, WA (US); Randolph A. Bentson, Seattle, WA (US); Andrew C. Berg, Kirkland, WA (US); John H. Hornbaker III, Seattle, WA (US); Leonard C. Janke, Bellevue, WA (US); James R. McCann III, Seattle, WA (US); Eric A. Peterson, Bothell, WA (US)

Correspondence Address: PERKINS COIE LLP, PATENT-SEA, P.O. BOX 1247, SEATTLE, WA, 98111-1247, US

(21) Appl. No.: 09/989,989

(22) Filed: Nov. 21, 2001

Related U.S. Application Data
(63) Continuation-in-part of application No. 09/534,836, filed on Mar. 24, 2000.
(63) Continuation-in-part of application No. 09/535,927, filed on Mar. 24, 2000.
(60) Provisional application No. 60/252,762, filed on Nov. 22, 2000.

(30) Foreign Application Priority Data
Mar. 24, 2000 (US) US00/07986

(51) Int. Cl. H04L 9/00

(52) U.S. Cl. 713/176

(57) ABSTRACT

A facility for conducting an election is described. The facility establishes a public key infrastructure for use in the election. The facility then employs the established key infrastructure in the operation of a voting site.

### CROSS-REFERENCE TO RELATED APPLICATIONS

This application claims the benefit of U.S. Provisional Application No. 60/252,762, filed Nov. 22, 2000, and is a continuation-in-part of each of U.S. patent application Ser. No. 09/534,836, filed Mar. 24, 2000; U.S. patent application Ser. No. 09/535,927, filed Mar. 24, 2000; and International Patent Application US00/07986, filed Mar. 24, 2000. Each of these four applications is incorporated by reference in its entirety.

### TECHNICAL FIELD

The present invention is directed to the field of electronic polling.

### BACKGROUND

In any election, it is important to accurately capture, preserve, and tabulate the intent of the eligible electorate. In recent elections, the voting systems employed have failed to meet these objectives in significant respects.

In typical modern voting systems, voter intent is translated to a binary representation to enable efficient and timely tabulation of votes. Paper-based systems, such as punch card and optical scanning systems, perform this translation in two steps. First, a voter translates his or her intent to a paper ballot, such as by punching small holes at particular locations on the ballot. Second, the paper ballot is digitized, such as with an optical or electrical scanner, yielding a binary representation of the voter intent. This binary representation is not typically kept for a significant period of time, but generally exists long enough to be added to a running total kept by the tabulation system.

It has been recognized that each of these two translation steps is subject to error. Typical examples include confusing ballot layouts that make it and ballots that may be incompletely punched, which make it difficult for voters to translate their intention to the paper ballot; scanning interfaces that are subject to misalignment, causing ballots to be inaccurately scanned; and translation and conversion programs that operate incorrectly or out of sync with the style of the paper ballot, causing correctly scanned votes to be mistabulated.

These potential errors are in fact realized somewhere in nearly every large-scale election. In response, many election officials have gravitated towards retaining the representation of that intent that is closest to the original—the paper ballots. When questions or issues arise, they turn to the paper ballots as the indicator of voter intent. Of course, this does nothing to solve the inaccuracies that can be introduced in the initial translation of intent to paper, nor those that arise from the troubles inherent in interpreting fundamentally analog data.

Finally, all voting systems must address questions regarding the preservation of intent, both before tabulation and after the election. Once again, paper based systems rely upon retention of the paper ballots themselves to act as the paramount indicator of the original voter intent. Of course, nothing in paper based systems inherently protects these ballots from modification, either inadvertent or intentional.

In view of these shortcomings, improved voting systems having any or all of the following characteristics would have significant utility: improved accuracy of the interface used by the voter to record his/her intent; reduced number of separate translations in the path from original voter intent to tabulatable data, which in turn reduces the number of possible translation errors; enabling the voter to verify that the tabulatable form of the ballot does accurately reflects his or her intent before it is included in the tally; and protection of the stored record of voter intent from modification, both inadvertent and intentional.

### BRIEF DESCRIPTION OF DRAWINGS

FIG. 1 shows selected components of a typical environment in which the facility operates.

FIG. 2 is a block diagram showing some of the components typically incorporated in at least some of the computer systems and other devices on which the facility executes.

FIG. 3 shows a typical distribution of functionalities of the facility across components in environments in which the facility typically operates.

FIG. 4 is a data flow diagram showing aspects of how ballots are typically processed by the facility.

FIG. 5 is a display diagram showing an initial instructional display typically displayed by the facility.

FIG. 6 is a display diagram showing a sample display presented by the facility for selecting a pair of candidates in a race for an office.

FIG. 7 is a display diagram showing the selection of a pair of candidates in a race.

FIG. 8 is a display diagram showing a warning against selecting more than the maximum number of candidates.

FIG. 9 is a display diagram showing the selection of a different pair of candidates.

FIG. 10 is a display diagram showing a sample display presented by the facility for a non-office ballot issue.

FIG. 11 is a display diagram showing the selection of an answer to a non-office ballot issue.

FIG. 12 is a display diagram showing a sample confirmation display presented by the facility.

FIG. 13 is a display diagram showing the display of a confirmation message.

FIG. 14 is a display diagram showing a concluding message typically displayed by the facility.

### DETAILED DESCRIPTION

A software facility for conducting an election (“the facility”) is provided. Embodiments of the facility use a specialized public key infrastructure to authorize poll workers to in turn authorize eligible voters to vote. Enough information is typically maintained for each voted ballot cast to trace it to the individual poll worker that authorized the voter who cast the ballot, through intermediate election officials, up to a single ultimate authority for authorizing eligible voters.

Embodiments of the facility provide a digital user interface used by authorized voters to vote a ballot. This interface prevents voters from partially marking their choices, or otherwise leaving their intent in question. This voted ballot is transformed from an initial internal for into an external form in which it is transmitted to a voted ballot repository, then transformed back into the internal form, which is displayed to the voter for confirmation. These steps help to ensure that voter intent is accurately represented in voted ballots.

A single “ballot style” is used to generate blank ballots, and accessed by all copies of the program that transforms voted ballots between internal and external form. In some embodiments, a specialized public key infrastructure is used to certify this ballot style for use in the election. The ballot style specifies the order of election races on blank and voted ballots, as well as the order of candidates. (As used herein, “races” include offices for which a human candidate is selected, as well as other ballot issues, such as referenda. “Candidates” include both human candidates, as well as possible responses to other ballot issues, such as whether to approve or reject a referendum.) Additionally, all copies of the ballot transformation program used in the election system are typically certified to be identical. These steps help to ensure that voter intent is not corrupted in the processing of voted ballots.

Embodiments of the facility provide safeguards against ballot tampering after ballots are voted. In some embodiments, each voted ballot is signed with a private key associated with the voter voting the ballot. This signature, together with the corresponding public key, establishes that the ballot has not been modified since being voted. These voter keys are optionally stored on one or more portable memory devices possessed by each voter. The voter's public key may be signed with the private key of an election worker who verifies that the voter is eligible to vote. Together, this information establishes that the voted ballot was voted by an eligible voter. In some embodiments, voted ballots are each encrypted with an election key, and are decrypted by the joint efforts of multiple parties, using a key sharing protocol, or other threshold decryption techniques. In some embodiments, a voting receipt is issued to the voter, which the voter or a proxy can use to verify that the ballot voted by the voter was received and counted in the election result. Also, some embodiments of the facility store voted ballots in random positions in a data structure, preventing the voted ballots from being associated with particular voters based upon the order in which voters voted their ballots.

By operating as described, embodiments of the facility provide several advantages, including: improving the accuracy with which the voter records his or her intent; reducing the number of separate translations in the path from original voter intent to tabulatable data, and thus reduce the number of possible translation errors; enabling the voter to verify that the tabulatable form of the ballot does accurately reflect his or her intent before it is included in the tally; and protecting the stored record of voter intent from modification, both inadvertent and intentional.

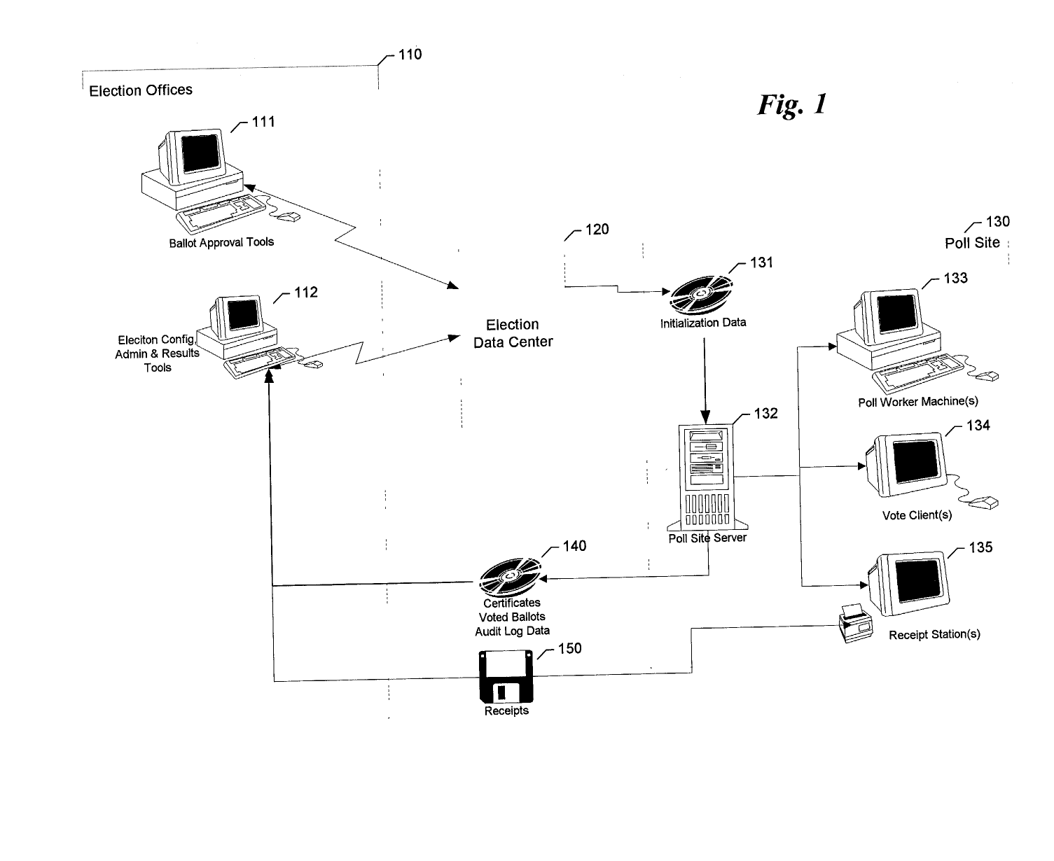

FIG. 1 shows selected components of a typical environment in which the facility operates. Those skilled in the art will appreciate that the facility may be employed in a wide variety of other environments, including those having different components. Ballot approval tools 111 are typically used by election officials to approve a particular ballot style for an election. Election officials typically also use the election configuration, administration, and results tools to prepare for and oversee an election. These tools communicate with an election data center 120, and are typically located in election offices 110. The election data center 120 provides data, such as initialization data 131, used at one or more poll sites 130. These poll sites may either be physical poll sites to which voters physically go in order to vote, or may be virtual poll sites accessed by voters remotely. Each poll site typically has a poll site server 132 that receives initialization data from the election data center. To the poll site server are connected one or more poll worker machines 133 used by poll workers to administer the polling within the poll site, including authorizing eligible voters to vote; vote clients 134 used by voters to generate voted ballots; and receipt stations 135 at which voters may obtain receipts evidencing their voting. These receipts 150 may be given to the voter in a variety of forms, including on paper or a variety of computer-readable portable memory devices. The receipts may also be conveyed to the election offices, along with certificates, voted ballots, and audit log data 140.

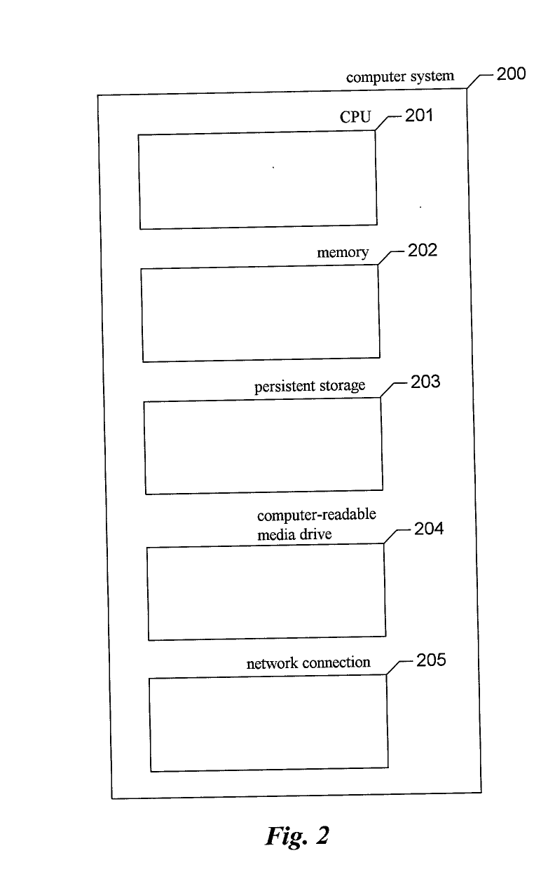

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are preferably used to support the operation of the facility, those skilled in the art will appreciate that the facility may be implemented using devices of various types and configurations, and having various components.

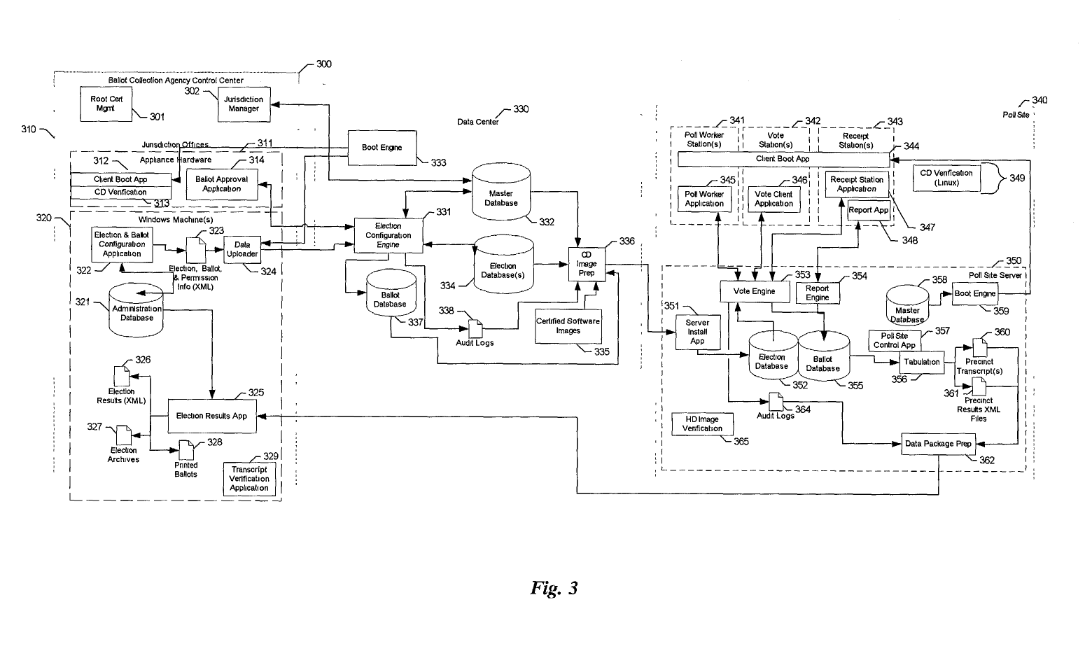

FIG. 3 shows a typical distribution of functionalities of the facility across components in environments in which the facility typically operates. Those skilled in the art will appreciate that functionalities of the facility may also be distributed in various other manners. A Ballot Collection Agency Control Center 300 houses remote data center control applications owned/maintained by a ballot collection agency. These include a Root Certificate Management Module 301 that provides secure storage and access policies for the private signing keys belonging to the Ballot Collection Agency, and a Jurisdiction Manager Module 302 comprising software for creating and modifying jurisdiction records in the Master Database 332, housed in the Data Center 330.

Installed in Jurisdiction Offices 310 are an Appliance Hardware Module 311 which comprises critical election creation and management hardware requiring high security as well as software necessary to operate the hardware. This module includes a Client Boot Application 312 which comprises boot sequence code identical to that run on the Vote Client in the poll site, a CD Verification 313 which comprises software to verify authenticity of Election Configuration CD (identical code is typically run in the poll site to prevent use of counterfeit CD), and a Ballot Approval Application 314 which comprises software for final ballot style (blank ballot) approval by jurisdiction. The code for ballot display used by the Ballot Approval Application 314 is identical to the code used for display by the Vote Client at the poll site. The Ballot Approval Application 314 also generates the jurisdiction root signature on all the individual ballot styles after ballot style review is completed favorably. Also installed in Jurisdiction Offices 310 are one or more Windows Machine(s) 320 which run election creation and management software that does not have high security requirements. This software includes an Administration Database 321 which comprises a database maintained by the jurisdiction for managing certificates, ballot styles, and election results, a Election & Ballot Configuration Application 322 which comprises software for creating precincts and ballots, Election, Ballot & Permission Info (XML) 323 which comprises digital data (and digital signature)—formatted according to specification—encapsulating the final state of the Administration Database 321 for election day, a Data Uploader 324 which comprises software for transferring Election, Ballot & Permission Info (XML) 323 to the Ballot Collection Agency Data Center 330 for archive and CD production, a Election Results Application 325 which comprises software for tabulating, displaying, auditing, and archiving election results, Election Results XML 326 which comprises digital data—formatted according to specification—encapsulating the final set of election results (or tallies), Election Archives 327 which provide long term storage of all data necessary to completely re-create election tabulation and audit, Printed Ballots 328 which comprise optional paper ballots printed from electronic data, and a Transcript Verification Application 329 which comprises software for verification of the election transcript. This application constitutes a complete data audit of election integrity. The module checks all signatures and certificate chains, decryptions, proofs of validity, ballot style signatures, etc.

A Data Center 330 embodies computing infrastructure maintained by Ballot Collection Agency. It includes an Election Configuration Engine 331 which comprises software that packages the data received via upload for efficient CD production, a Master Database 332 which comprises a database for storing jurisdiction information originating from the Jurisdiction Manager 302 along with election specific information pertaining to audit of the election construction process. The latter information originates from the Ballot Approval Application 314. (This database is the same as database 358.) The Data Center 330 further includes a Boot Engine 333 which comprises software for managing poll site network configuration addresses and other constants. These constants are needed by the poll site applications at initialization, and hence must be supplied on the election CD. (Boot Engine 333 is typically the same as Boot Engine 359.) The Data Center 330 further includes one or more Election Database(s) 334 which comprise databases for storing all information essential to election day operation, including ballot styles, and complete jurisdiction certificate tree (PKI). (Election Database 334 is typically the same as Election Database 352.) The Data Center 330 further includes Certified Software Images 335 which comprise all election related software running in the Data Center has been certified and reviewed by an independent testing authority, a CD Image Preparation Module 336 which comprises software and hardware for creating CD copies that are used at the Poll Site during all election operations. These CDs include both generic system software and all data that is jurisdiction specific, including ballot style and PKI information. The Data Center 330 further includes a Ballot Database 337 which comprises a database structure for receiving and storing voted ballots. In the Data Center, this amounts to an empty copy of a database “template”. The structure is necessary for proper initialization of the Poll Site Server at election startup. It does not, at this point, contain any ballots. The Data Center 330 further includes Audit Logs 338 which comprise operational audit data required by law. A Poll Site 340 includes one or more Poll Worker Station(s) 341 which individually comprise a computer operated by a poll worker for the purposes of issuing voter certificates and keys, as well as test certificates and keys, one or more Vote Station(s) 342 which individually comprise a computer for core vote casting interaction. Functions of a Vote Station 342 include display of appropriate ballot style, user interface for collecting voter choices, confirmation screen generation, ballot encoding, ballot encryption, ballot signing, and ballot submission. A Poll Site 340 further includes one or more Receipt Station(s) 343 which individually comprise a computer that receives and verifies the voter's receipt for voting (digitally signed using a private key stored only during election hours). This receipt is positive confirmation to the voter that his/her ballot was successfully added to the ballot box data, and serves also as irrefutable proof thereof. The Receipt Station also stores multiple copies of the all receipts on redundant storage devices. In case the voter does not provide his/her receipt to the tabulation process, either personally or by proxy, these storage devices still provide protection against ballot loss or deletion. A Poll Site 340 further includes a Client Boot Application 344 which comprises boot sequence code identical to that run in the Jurisdiction Offices to for the Ballot Approval Application 314, a Poll Worker Application 345 which comprises software for generating and signing voter keys and certificates. Certificates contain precinct and ballot style information in addition to the voter public key. A Poll Site 340 further includes a Vote Client Application 346 which comprises software run on the Vote Station 342, implementing all functionality described therein, a Receipt Station Application 347 which comprises software run on the Receipt Station 343, implementing all functionality described therein, a Report Application 348 which comprises software to generate a “state of the ballot box” report. This application is Used to verify empty ballot box before opening polls. It also can be used for end of day reports for multi-day elections. It also can provide for the counting of test ballots. A Poll Site 340 further includes a CD Verification Module 349 which comprises software for verifying the integrity of the election specific and generic software distribution which makes up the entire contents of the election CD. This software is run on a Linux computer. A Poll Site 340 further includes a Poll Site Server 350 which embodies software and hardware implementing all functionality associated with the digital ballot box; and in particular embodies the ballot box which is able to collect both official ballots and test ballots. A Poll Site Server 350 includes a Server Install Application 351 which comprises software for configuring the Poll Site Server with the appropriate initialization data, an Election Database 352 which comprises a database for storing all information essential to election day operation, including ballot styles, and complete jurisdiction certificate tree (PKI) (the same as 334), a Vote Engine 353 which comprises the core software module for receiving and integrating all data produced by the Poll Worker Application 345, the Vote Client Application 346), and the Receipt Station Application 346. Most importantly this data includes all voter certificates and voted ballots. The Vote Engine 353 is also responsible for providing the correct ballot style to voter based on the voter certificate information contained on the voter portable storage device (IButton). A Poll Site Server 350 further includes a Report Engine 354 which comprises software for generating miscellaneous election status and readiness reports, a Ballot Database 355 which comprises a database structure for receiving and storing voted ballots initialized with the structure in 337, a Tabulation Process 356 which comprises the vote counting process, a Poll Site Control Application 357 which comprises software for high level management of Poll Site Server 350, a Master Database 358 which comprises a database for storing jurisdiction information originating from the Jurisdiction Manager Module 302 along with election specific information pertaining to audit of the election construction process. The latter information originates from the Ballot Approval Application 314 (the same as 332). A Poll Site Server 350 further includes a Boot Engine 359 which comprises software for managing poll site network configuration addresses and other constants. These are needed by the poll site applications at initialization, and hence must be supplied on the election CD (the same as 333.) A Poll Site Server 350 further includes Precinct Transcripts 360 which individually comprise the complete record of all data required to prove the integrity of the election as conducted in a given precinct, Precinct Results XML Files 361 which individually comprise digital data—formatted according to specification—encapsulating the final set of results (or tallies) for a given precinct, a Data Package Preparation Module 362 which comprises software and hardware responsible for creating complete permanent archive of all election information. This includes information created as a result of the voting process, such as the election transcript, all voter receipts, and the audit logs, as well as election creation information such as the PKI and ballot styles. A Poll Site Server 350 further includes Audit Logs 364 which comprise operational audit data required by law, and an HD Image Verification Module 365 which comprises software for verifying the integrity of the Poll Site Server writeable media (disk drive). The value of doing this integrity verification is to prevent tampering with the Poll Site Server 350 software during any unattended periods after initial software installation.

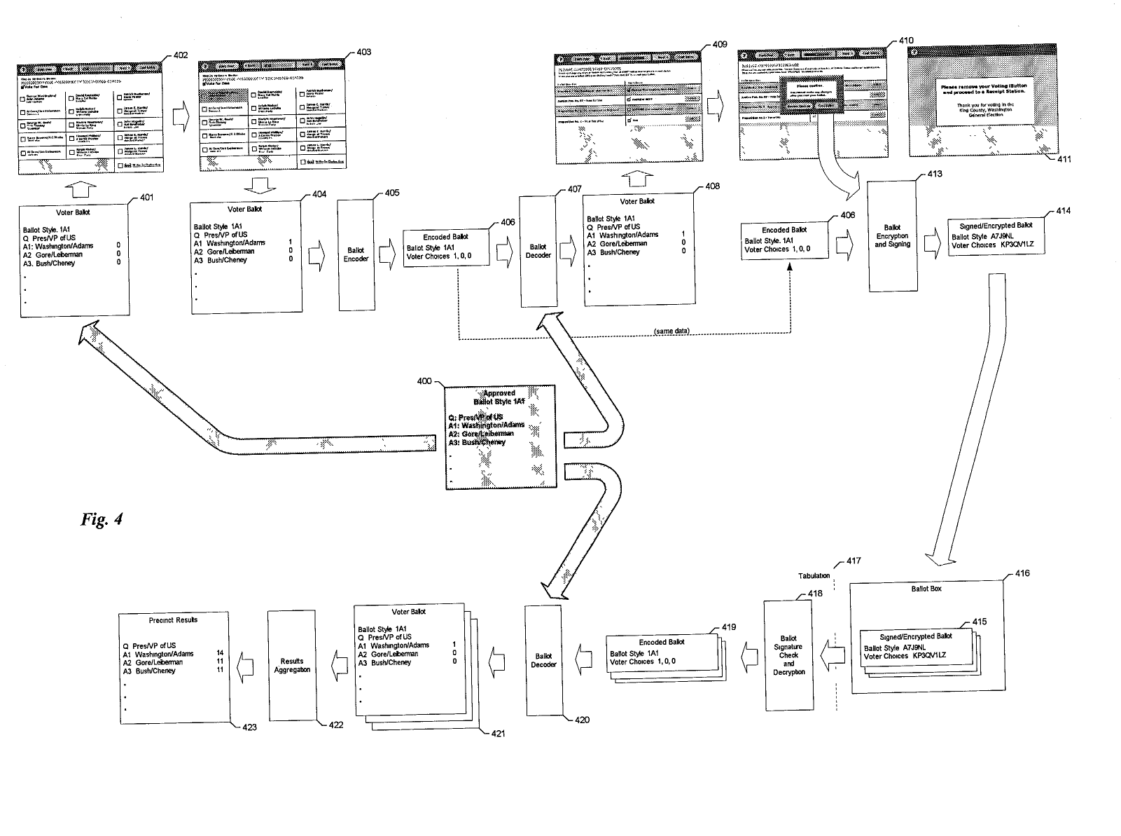

FIG. 4 is a data flow diagram showing aspects of how ballots are typically processed by the facility. The facility generates and processes a ballot based upon a ballot style 400. The ballot style is assigned a ballot style number, here “1A1.” The ballot style defines the content of a blank ballot by listing each ballot issue in the order that they are presented on the ballot. For each ballot issue, the ballot style lists the issue question, such as the office to be filled or the referendum to be decided, and in ordered list of the possible ballot answers, such as the candidate to elect or the action to be taken on the referendum. The facility uses the ballot style to generate an internal representation 401 of a blank ballot.

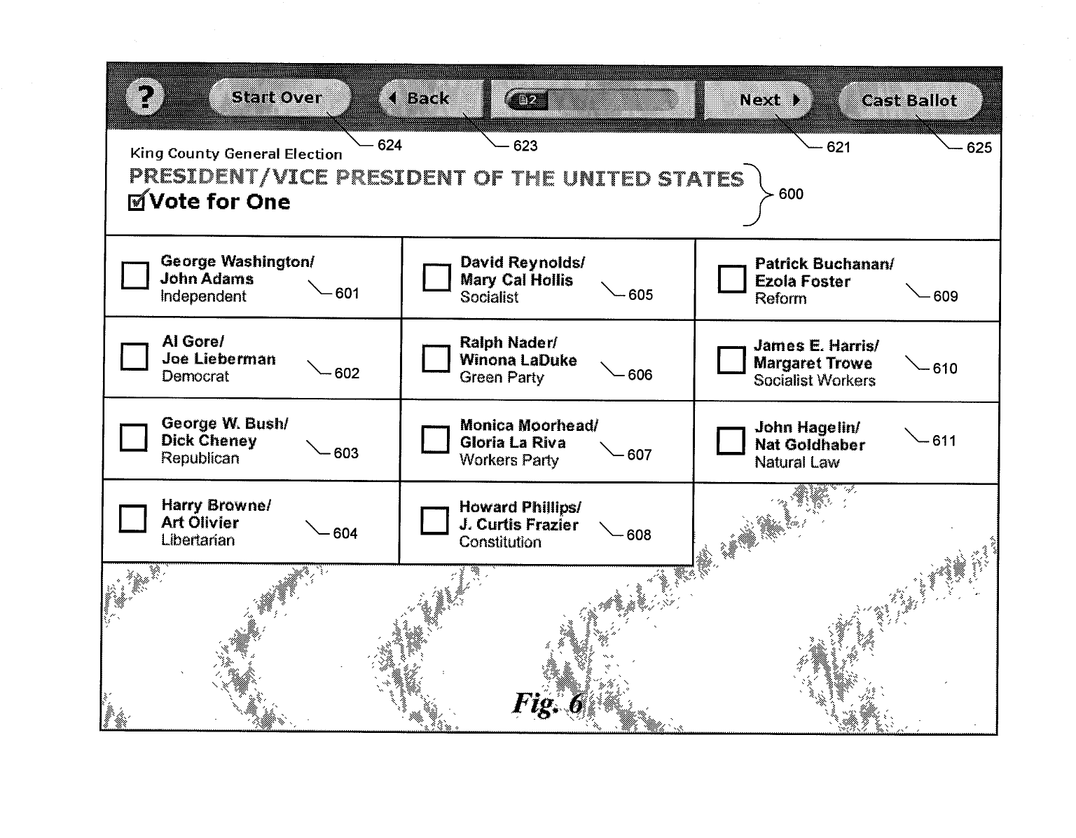

It can be seen in the internal representation of the blank ballot that an initial response of “0” is listed for each issue answer. The facility uses internal representation of blank ballot 401 to generate an initial display 402 for the first ballot issue, in which no issue answer is selected, i.e., no candidate is selected. This display is discussed below in greater detail in conjunction with FIG. 6.

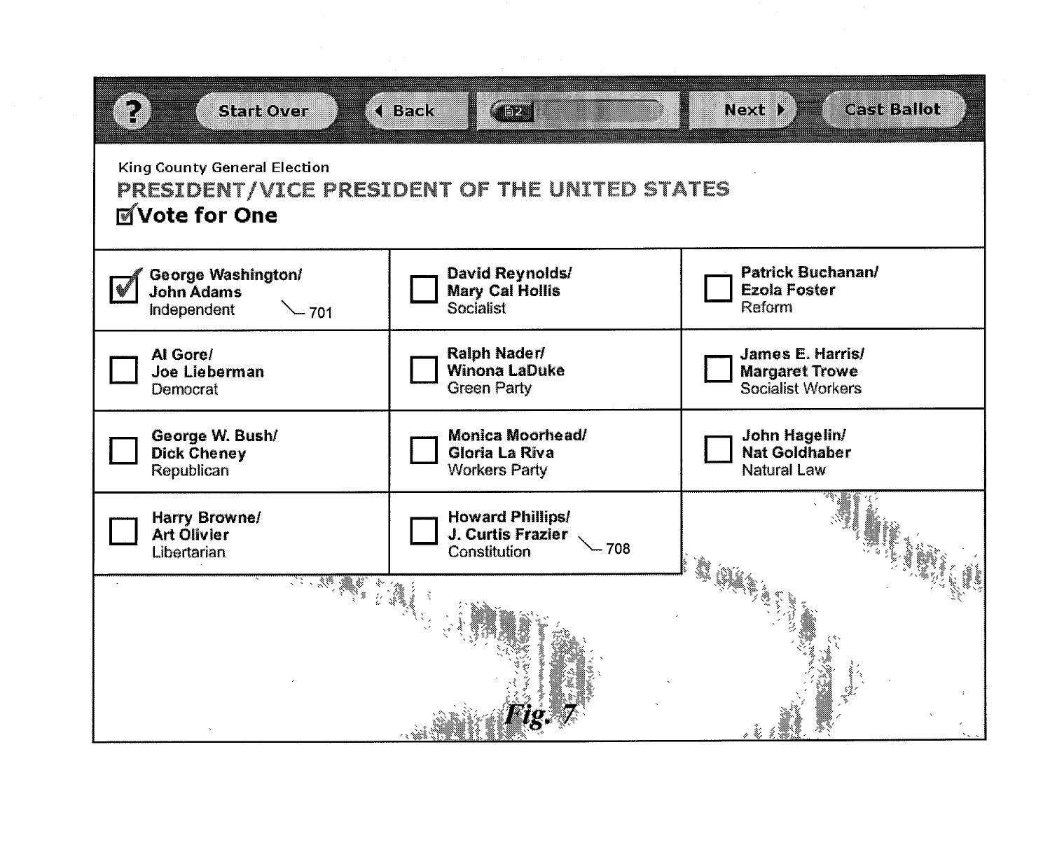

When the voter selects a candidate for the President and Vice President race, the facility updates internal representation of the blank ballot 401 to ballot internal representation 404 by changing the response to answer one for question one from “0” to “1.” The facility also updates display 402 to produce display 403 in which the selected candidate is displayed. Display 403 is discussed in greater detail below in conjunction with FIG. 7.

If additional ballot issues remain, the facility repeats the above procedure to enable the voter to select answers for each of these ballot issues. When the voter has selected answers for each of the ballot issues, the facility uses a ballot encoder module 405 to transform internal representation of the voted ballot 405 into an encoded, or “external” representation in which the voted ballot can be transmitted to and stored in a ballot box. It can be seen in this external representation 406 that it identifies the ballot style used to generate the ballot, and lists, in order, the values indicating which of the issue answers the voter selected.

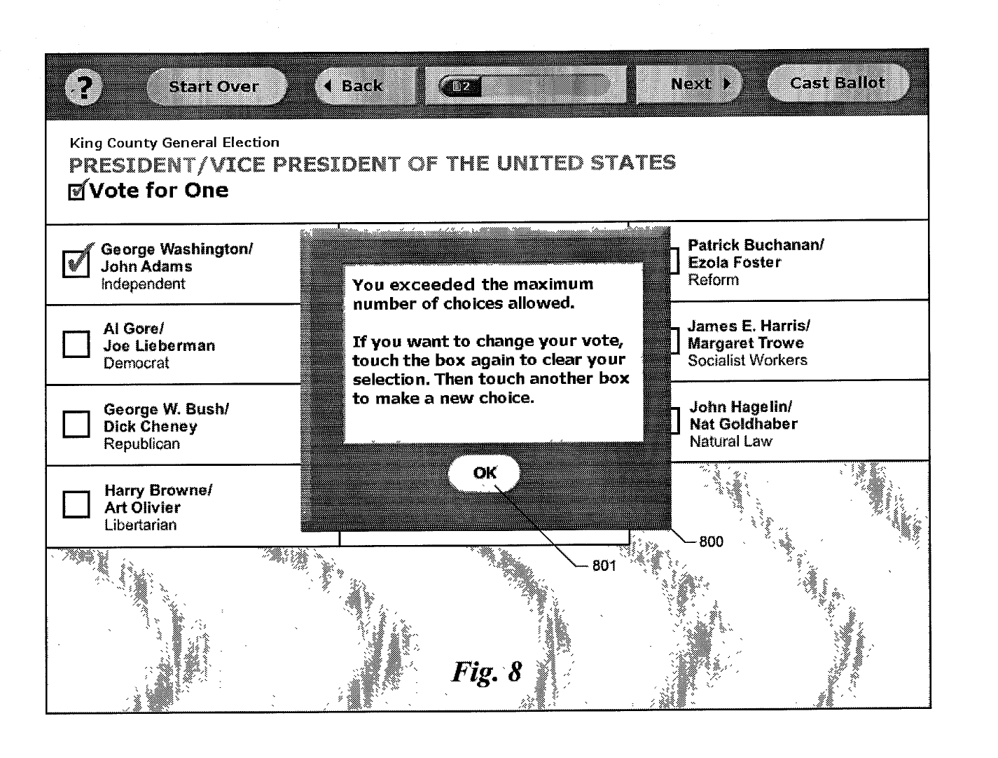

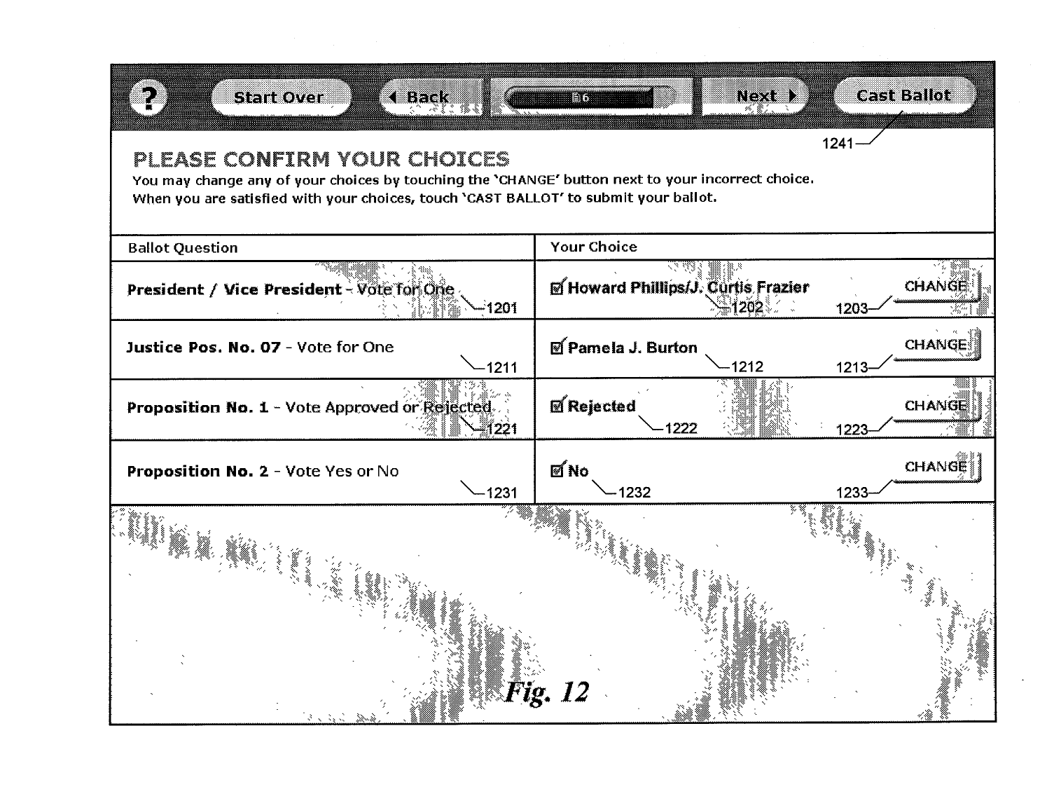

The facility then executes a ballot decode module 407 in order to transform the external representation of the voted ballot 406 produced by the ballot encoder into a new internal representation 408 of the voted ballot. Ballot encoder module 407 provides the same functionality as ballot decoder module 420 used in the tabulation process. In some embodiments, this module is identical, and certified as such by election officials and/or independent auditors. The facility uses this new internal representation of the voted ballot 408 to generate a display 409 of the selections made by the voter for confirmation purposes. Display 409 is discussed in greater detail below in conjunction with FIG. 12. Because of the new internal representation of the voted ballot 408 is the result of encoding, then decoding the initial internal representation of the ballot, as will be the internal representation 421 of the ballot that is eventually tabulated, display 409 produced for confirmation by the voter of the voter's selection is ensured to reflect the selections that will ultimately be tallied if these selections are confirmed by the voter. The facility generates display 410, which explicitly asks the voter to confirm the selections shown in the confirmation display. This display is discussed in greater detail below in conjunction with FIG. 8. When the voter does so, the facility executes a ballot encryption and signing module 413 to transform the external representation of the voted ballot 406 into a signed and encrypted external representation of the voted ballot 414. The ballot is typically signed with a private key belonging to the voter, which corresponds to a public key stored by an election worker when the election worker identifies the voter as an eligible voter. “Signing” as used herein refers to generating a digital signature, such as an RSA signature, as is described in Chapter 11 of Menezes, A. J., Handbook of Applied Cryptography, CRC Press, 1996, which is hereby incorporated by reference in its entirety. The encryption performed by module 413 preferably includes encrypting every voted ballot with a single election public key. In some embodiments, the facility stores the private key for the voter on a portable computer-readable memory device, enabling the user to provide the private key to the computer system used to generate the voted ballot. In some cases, the private/public key pair for the voter is generated by the voter and carried to the voting site on this device.

The facility stores this signed and encrypted voted ballot 414 with other signed and encrypted voted ballots 415 voted by other voters in a ballot box 416. In some embodiments, the ballot box 416 is maintained in persistent storage of the poll site server computer system 132 shown in FIG. 1.

In some embodiments, signed and encrypted ballots are each stored in a random position in the ballot box, in order to prevent the signed and encrypted ballot voted by a particular voter from being identified based upon the order in which the voters voted. In some embodiments, this involves selecting a position for each ballot using a reliable source of random numbers, such as a hardware random number generator. In some cases, this involves dividing each ballot into a short portion containing data items that is desirable to index and a longer portion containing data items that is less important to index. The shorter portion is stored in a randomly-selected database record, while the longer portion is stored in a corresponding position in a file system file.

Block 417 illustrates the process of tabulating voted ballots. The facility executes a ballot signature check and decryption module 418 to produce from the ballot box a quantity of external representations of voted ballots 419 that have been (1) been signed with the private key of an authorized voter, and (2) decrypted. To check the authorization of the voter, the facility typically uses one or more voter public keys that it has stored to determine if the private key corresponding to one of these public keys was used to sign the ballot. If so, the facility determines whether this public key was signed with a private key of an election worker, and whether that election worker's authority to authorize voters is traceable to the root of the voter authorization tree. If either of these conditions are not satisfied, the facility omits the encoded ballot from the encoded ballots 419 passed forward for tabulation. In some cases, the decryption process involves decrypting each ballot with a single private key corresponding to the public key used to encrypt the ballots. In other embodiments, a key-sharing protocol is used to obtain joint decryption of the voted ballots using a private key shared among a group of different decryption servers. The facility then executes the ballot decoder module 420, which uses the ballot style 400 to transform each external representation 419 of a voted ballot into a corresponding internal representation 421 of that voted ballot. As noted above, ballot decoder 420 operates in the same manner as ballot decoder 407, and, in some embodiments, is identical. It can be seen that the produced internal representations 421 of voted ballots include the same internal representation of a voted ballot as internal representation 408 used to present confirmation display to the voter that voted that ballot. The facility then executes a results aggregation module in order to tally the internal representations 421 of the voted ballots to produce election results 423, in which the values attributed to each of the ballot issue answers are aggregated, such as by summing.

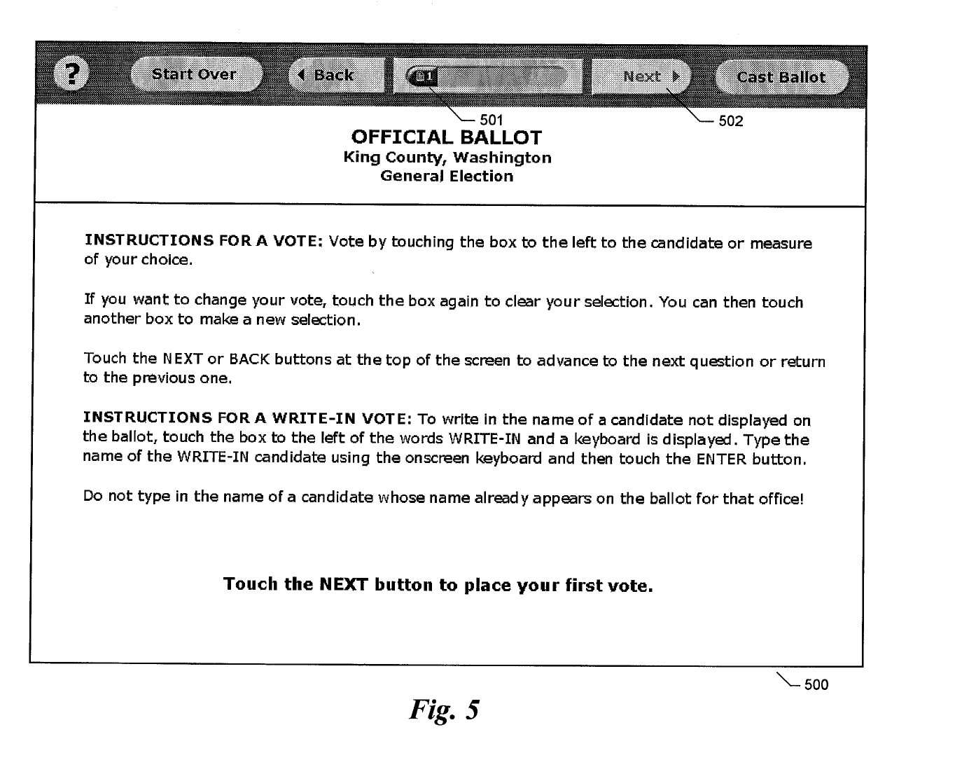

FIGS. 5-14 are display diagrams showing typical displays generated by the facility to enable a voter to complete and confirm a ballot. In some embodiments, the facility presents these displays on a touch-screen monitor so that the voter can select a point on the display by touching a corresponding point on the monitor.

FIG. 5 is a display diagram showing an initial instructional display typically displayed by the facility. The display includes an instructional message 500 about how to complete and confirm a ballot. The display also includes a progress indicator 501 that shows the voter's progress in completing the ballot, as well as a next button 502 for displaying the next display in the sequence of displays for completing the ballot.

FIG. 6 is a display diagram showing a sample display presented by the facility for selecting a pair of candidates in a race for an office. The display of FIG. 6 is typically displayed by the facility when the user selects the next button 502 shown in FIG. 5. The display includes an indication 600 of the office to be filled, as well as instructions for how to vote for candidates for that office. That is, indication 600 indicates that the office is President and Vice President of the United States, and that the voter should vote for a single pair of candidates. Entries containing eleven pairs of candidates 601-611 are listed, each with an empty check box. The absence of any checked check boxes indicates that no pair of candidates has yet been selected by this voter. To select a pair of candidates, the voter may select the check box for those candidates. For example, to select independent candidates George Washington and John Adams, the voter selects the check box for item 601. The voter may also click the next button 621 in order to display the next ballot issue without voting on the current ballot issue. The voter may also select a back button 623 to retreat one display in the sequence of displays, or select a start over button 624 in order to return to the beginning of the sequence. The voter may also select a cast ballot button 625 in order to finish the voting process without voting in any of the subsequent ballot issues.

FIG. 7 is a display diagram showing the selection of a pair of candidates in a race. The facility presents this display in response to the voter's touching the check box in entry 601 shown in FIG. 6. It can be seen in entry 701 that this check box is now checked. At this point, the voter may attempt to select a different pair of candidates, such as those shown in entry 708.

FIG. 8 is a display diagram showing a warning against selecting more than the maximum number of candidates. FIG. 8 is displayed when the voter touches the check box in entry 708 shown in FIG. 7. The warning 800 instructs the voter to deselect selected choices before selecting additional choices. The voter may select OK button 801 in order to remove the warning message and return to the display shown in FIG. 7.

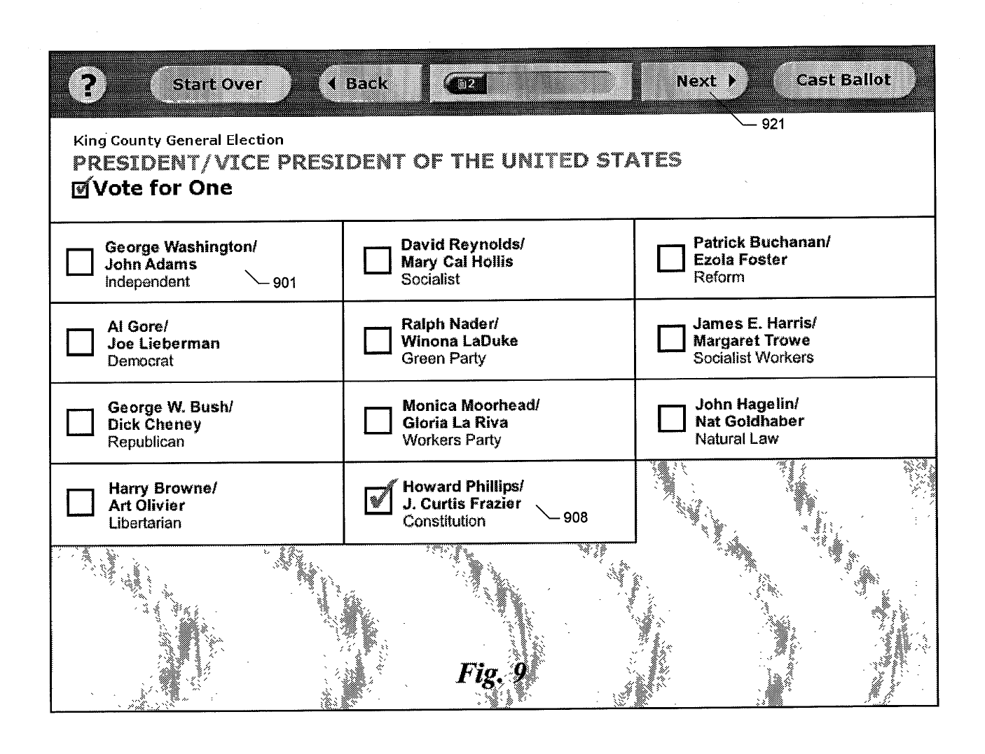

FIG. 9 is a display diagram showing the selection of a different pair of candidates. FIG. 9 is displayed in response to the voter's deselection of the Washington/Adams candidate pair by selecting entry 701 shown in FIG. 7 to return to the display of FIG. 6, and then selecting entry 608 shown in FIG. 6. It can be seen by the check box in entry 908 that the Phillips/Frazier candidate pair is now selected in the President/Vice President race. Having selected this candidate pair, the voter may select next button 921 in order to proceed to the display for the next ballot issue.

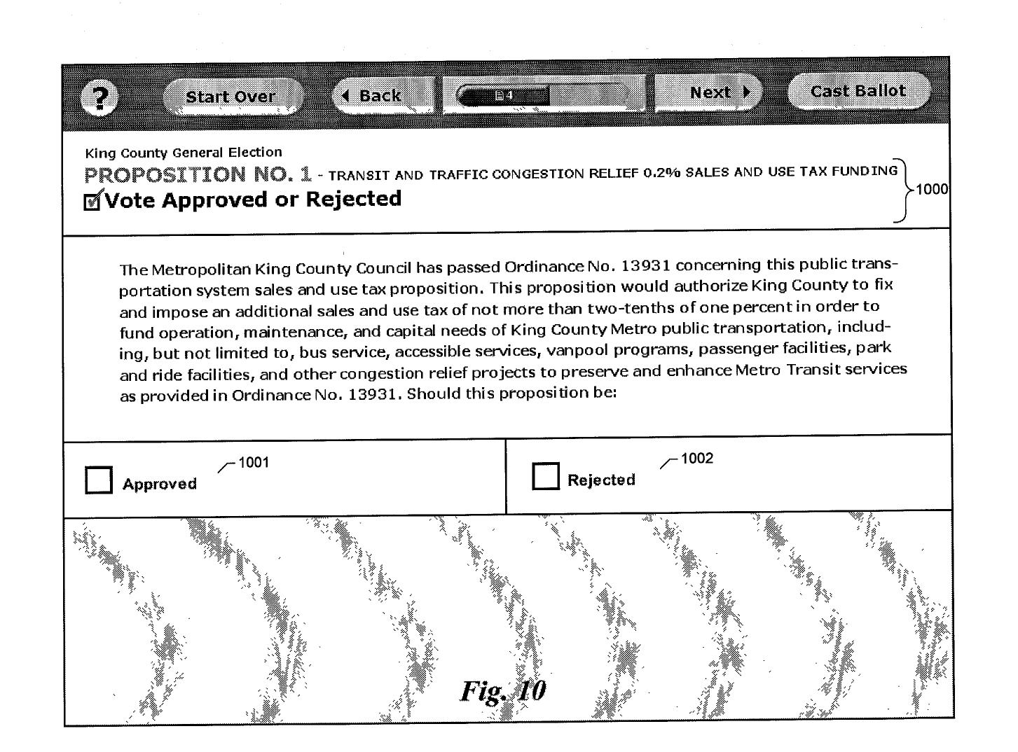

FIG. 10 is a display diagram showing a sample display presented by the facility for a non-office ballot issue. This display includes an indication 1000 of the nature of the ballot issue and instructions for voting. The display also contains an entry 1001 that can be selected to approve this proposition, and an entry 1002 that may be selected in order to reject this proposition.

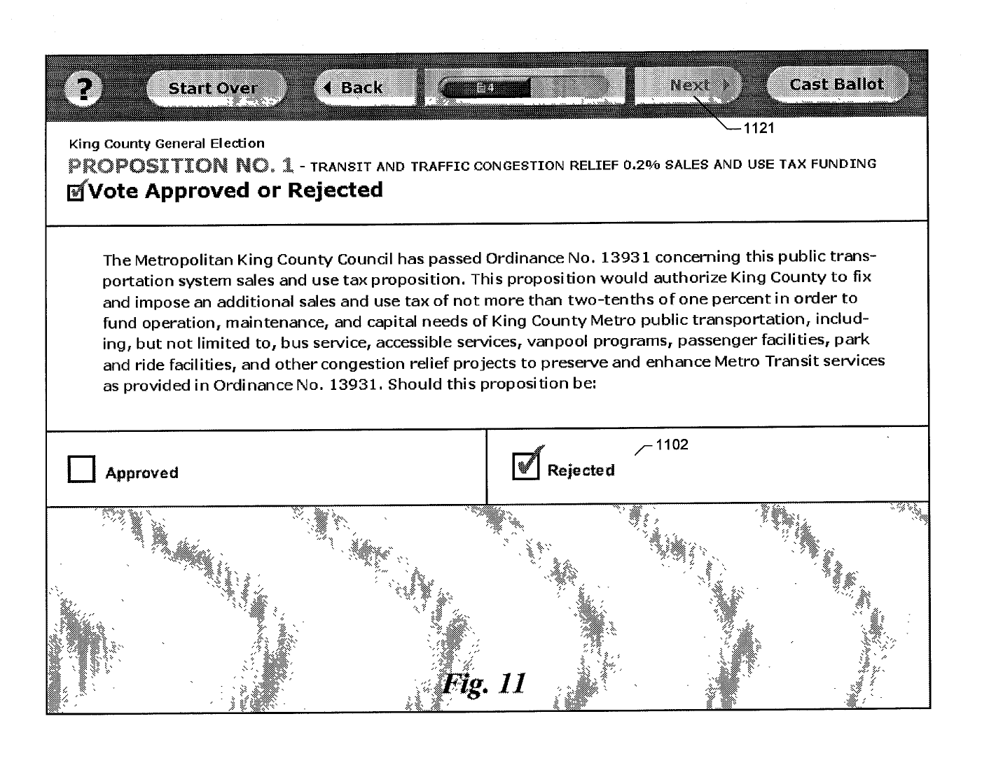

FIG. 11 is a display diagram showing the selection of an answer to a non-office ballot issue. It can be seen that the voter selected entry 1002 shown in FIG. 10, and that entry 1102 is now selected. The voter may select next button 1121 in order to proceed to the display for the next ballot issue.

FIG. 12 is a display diagram showing a sample confirmation display presented by the facility. For each ballot issue, the display includes the ballot question for the ballot issue, as well as the ballot choice selected by the voter. For example, for the first ballot issue, the display includes an entry 1201 indicating that the ballot question is “President/Vice President—vote for one,” and an entry 1202 showing the candidate selected by the voter for this office, Phillips/Frazier. A change button is also displayed for each ballot question. For example, a change button 1203 is displayed for the first ballot issue. The voter may select this button in order to return to the display shown in FIG. 9, where the voter may select a different pair of candidates for this race than the pair shown in FIG. 12. After any such changes are completed, the voter may select a cast ballot button 1241 in order to confirm the presently-selected issue choices.

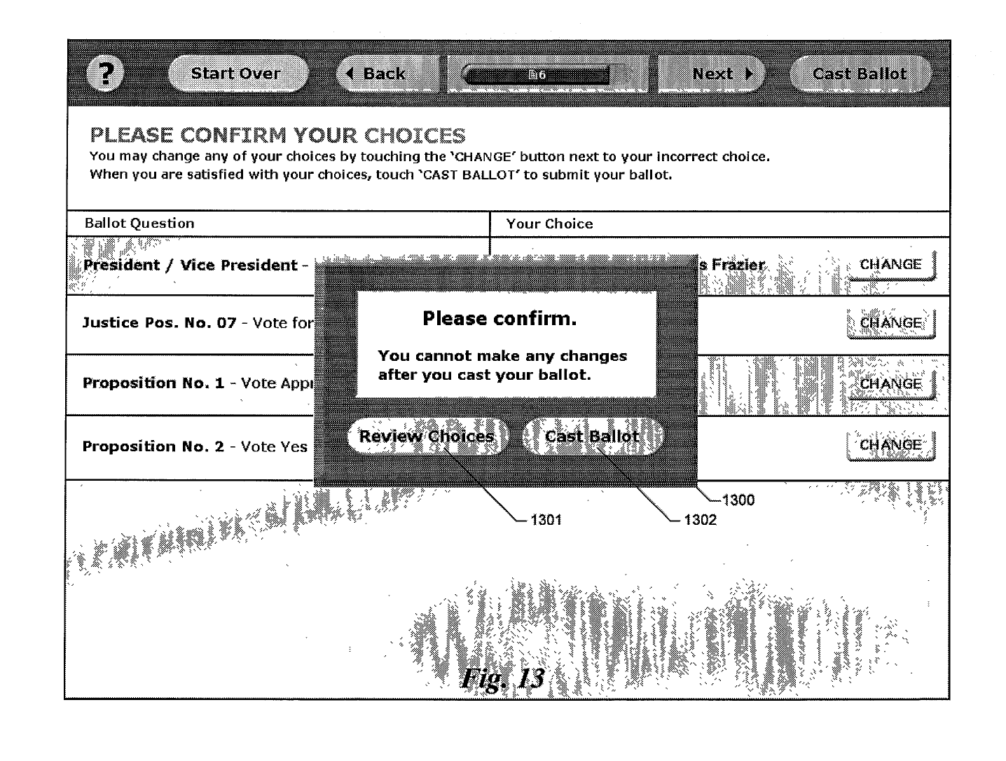

FIG. 13 is a display diagram showing the display of a confirmation message. The confirmation message 1300 includes a button 1301 that the voter may select in order to review his or her choices, and a button 1302 that the voter may select in order to cast his or her ballot with the current selections.

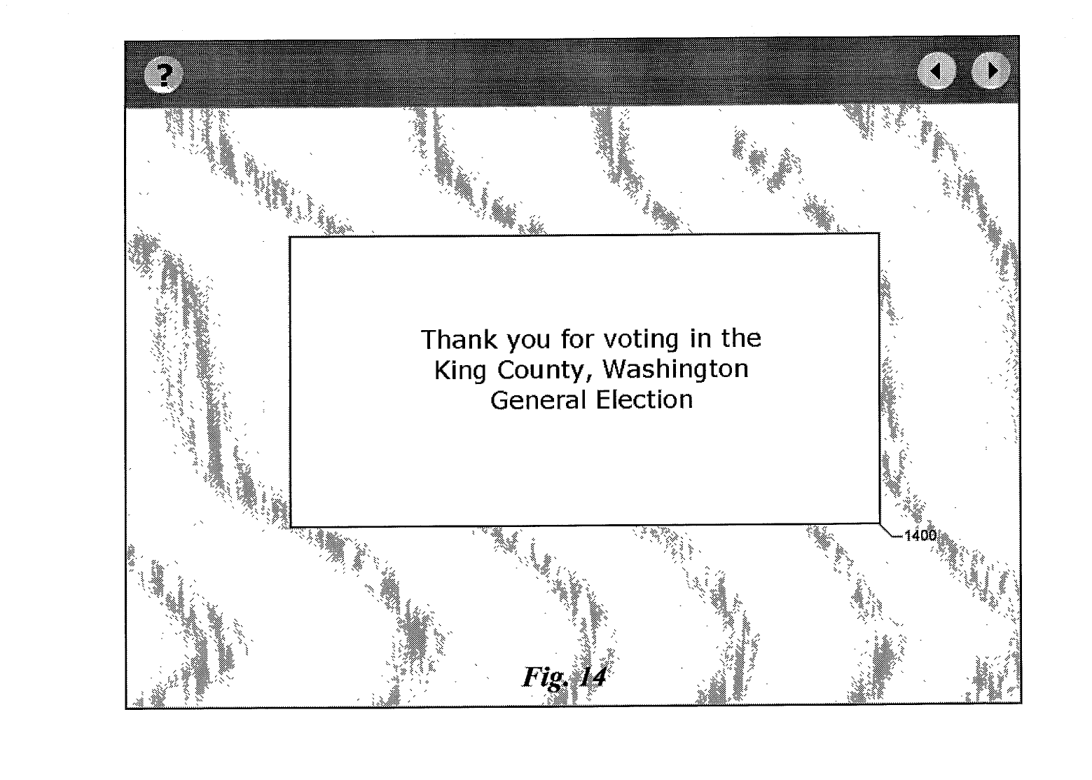

FIG. 14 is a display diagram showing a concluding message typically displayed by the facility. The concluding message 1400 indicates to the voter that his or her voted ballot has been accepted.

It will be appreciated by those skilled in the art that the above-described facility may be straightforwardly adapted or extended in various ways. While the foregoing description makes reference to preferred embodiments, the scope of the invention is defined solely by the claims that follow and the elements recited therein.

I/We claim:

1. A method in a computing system for conducting an election, comprising:
for each voter identified by an election worker as being eligible to vote:
generating a private key and a public key for the voter;
issuing to the voter the only copy of the generated voter private key;
signing the generated voter public key with a private key of the election worker who identified the voter;
storing a data structure containing the voter public key signed with the election worker private key;
enabling the voter to generate a voted ballot by selecting a candidate in at least one election race;
encoding the generated voted ballot by executing first distinguished code;
decoding the encoded voted ballot by executing second distinguished code;
prompting the voter to approve the decoded voted ballot
if the voter approves the decoded voted ballot:
encrypting the encoded voted ballot with a single election public key;
signing the voted ballot with the voter private key;
storing the signed voted ballot for counting;
for each stored signed voted ballot:
if the signed voted ballot was signed with a private key corresponding to a stored voter public key,
if the stored voter public key was signed with the private key of an election worker whose public key was signed by an election official whose authority derives from an ultimate election authority,
transmitting the unsigned voted ballot to each of a plurality of decryption servers;
receiving from each of the plurality of decryption servers a response containing a partial decryption result;
combining the received responses to obtain a decrypted encoded voted ballot;
decoding the decrypted encoded voted ballot by executing the second distinguished code;
storing the decoded decrypted voted ballot; and
for each stored decoded decrypted voted ballot, tallying the decoded decrypted voted ballots.

2. The method of claim 1 wherein the first distinguished code, when executed, accesses a ballot style definition to determine how to encode a voted ballot, and wherein the second distinguished code, when executed, accesses a ballot style definition to determine how to decode a voted ballot.

3. A method in a computing system for facilitating the identification of uncounted voted ballots in an election, comprising:
when a voter submits a voted ballot, issuing a value indicating that the voter has submitted a voted ballot;
associating the receipt value with the voted ballot submitted by the voter; and
when the voted ballot submitted by the voter is counted, adding the receipt value to a list of receipt values associated with counted voted ballots, such that, if the issued receipt value does not appear in the list of receipt values associated with counted voted ballots, the voted ballot with which the missing receipt value is associated may be identified as uncounted.

4. The method of claim 3, further comprising storing the issued receipt value in a portable memory device for the voter.

5. The method of claim 3, further comprising printing the issued receipt value on a physical object.

6. The method of claim 3, further comprising printing the issued receipt value on a physical object in human-readable form.

7. The method of claim 3, further comprising printing the issued receipt value on a physical object in machine-readable form.

8. The method of claim 3, further comprising printing the issued receipt value on a sheet of paper.

9. The method of claim 3, further comprising encoding the issued receipt value in a physical object.

10. The method of claim 3, further comprising transmitting the receipt value to a plurality of recipient computer systems, the recipient computer systems each being under the control of a different entity.

11. The method of claim 10 where in the recipient computer systems are selected by the voter.

12. The method of claim 3 wherein the receipt number is a public key assigned to the voter.

13. The method of claim 3 wherein the receipt number is a public key assigned to the voter, signed with the private key of an election worker who authorized the voter to vote.

14. The method of claim 3 wherein the issued receipt value is a signature of the voted ballot using a private key of a vote collection authority.

15. The method of claim 14, further comprising publishing a private key corresponding to the private key of a vote collection authority in advance of issuing the receipt value.

16. A portable memory device issued to an authorized voter, containing a private key assigned to the authorized voter,
such that the portable memory device may be used to authorize a ballot voted by the authorized voter by using the contained private key to sign a representation of the ballot voted by the authorized voter.

17. The portable memory device of claim 16 wherein the portable memory device contains the only copy of the private key in existence.

18. The portable memory device of claim 16 wherein the portable memory device further contains a public key corresponding to the voter's private key.

19. The portable memory device of claim 18 wherein the public key is signed using the private key of a poll worker who authorized the voter.

20. The portable memory device of claim 16 wherein the portable memory device further contains receipt information evidencing voting by the voter.

21. The portable memory device of claim 16 wherein the contents of the portable memory device comprise a voter certificate.

22. A pair of portable memory devices used by a voter, a first portable memory device of the pair containing a private key generated by the voter, a second portable memory device of the pair containing a public key generated by the voter corresponding to the private key contained in the first portable memory device,
such that the first portable memory device may be surrendered to an election official that has approved the voter's participation in the election, enabling the election official to copy the public key into a public key store to evidence the voter's participation in the election without receiving the private key, and such that the second portable memory device may be retained by the voter and used to sign a representation of a ballot cast by the voter.

23. A method in a voting station computer system for obtaining a voter's verification of a ballot voted the voter, comprising:
in at least one election race, receiving input from the voter selecting a candidate in the race;
in response to the input from the voter, generating a first internal representation of the voted ballot:
translating the first internal representation of the voted ballot into an external representation of the voted ballot;
translating the external representation of the voted ballot into a second internal representation of the voted ballot;
using the second internal representation of the voted ballot to generate a confirmation display showing the candidates selected by the voter; and
if and only if the voter grants confirmation of the confirmation display, transmitting the external representation of the voted ballot to another computer system for storage.

24. The method of claim 23 wherein translating the external representation of the voted ballot into a second internal representation of the voted ballot is performed by executing a distinguished body of code, the method further comprising, in a computer system other than the voting station computer system, executing the distinguished body of code to translate the external representation of the voted ballot into a third internal representation of the voted ballot.

25. The method of claim 24, further comprising tallying the third internal representation of the voted ballot.

26. The method of claim 24, further comprising verifying that the distinguished body of code executed in the voting station computer system is the same as the distinguished body of code executed in the computer system other than the voting station computer system.

27. The method of claim 24 wherein the distinguished body of code is executed on the computer system to which the external representation of the ballot for the voter is transmitted.

28. The method of claim 24 wherein the distinguished body of code is executed on a computer system other than the voting station computer system, and other than the computer system to which the external representation of the voted ballot is transmitted.

29. A computer-readable medium whose contents cause an originating computer system to verify user input by:
receiving user input;
generating a first internal representation of the user input;
translating the internal representation of the user input into an external representation of the user input;
translating the external representation of the user input into a second internal representation of the user input;
using the second internal representation of the user input to generate a confirmation display showing the user input; and
if and only if the user grants confirmation of the confirmation display, transmitting the external representation of the user input to a destination computer system for processing.

30. The method of claim 29 wherein translating the external representation of the user input into a second internal representation of the user input is performed by executing a distinguished body of code in the originating computer system, and wherein the contents of the computer-readable medium further cause a destination computer system to:
execute the distinguished body of code to translate the external representation of the user input into a third internal representation of user input; and
process the third internal representation of the user input.

31. A method in a computing system for completing a blank ballot, comprising:
displaying a list of two or more candidates;
receiving first user input selecting a first one of the candidates;
in response to receiving the first user input, displaying an indication that the first candidate is selected;
after receiving the first user input, receiving second user input selecting a second one of the candidates;
in response to receiving the second user input, continuing to display an indication that the first candidate is selected;
after receiving the second user input, receiving third user input deselecting the first candidate;
in response to receiving the third user input, displaying an indication that no candidate is selected;
after receiving the third user input, receiving fourth user input selecting the second candidate; and
in response to receiving the fourth user input, displaying an indication that the second candidate is selected.

32. The method of claim 31, further comprising issuing a voted ballot on which the second candidate is selected.

33. The method of claim 31, further comprising, in response to receiving the second user input, displaying an indication that the currently-selected candidate must be deselected before another candidate may be selected.

34. The method of claim 31 wherein the first, second, third, and fourth user input is received from a user via a touch display.

35. A method in a computing system for completing a blank ballot, comprising:
displaying a list of candidates, none of which is initially selected, up to a maximum number of which may be selected;
receiving instances of user input each identifying a candidate on the list;
in response to receiving an instance of user input identifying a candidate from the list:
if the identified candidate is presently selected, updating the displayed list of candidates to deselect the identified candidate;
if the identified candidate is not presently selected, if the maximum number of candidates are not presently selected, updating the displayed list of candidates to select the identified candidate; and
if the identified candidate is not presently selected, if the maximum number of candidates are presently selected, maintaining the displayed list of candidates unchanged.

36. The method of claim 35, further comprising, in response to receiving an instance of user input identifying a candidate from the list, if the identified candidate is not presently selected, if the maximum number of candidates are presently selected, displaying an indication that a candidate must be deselected before any additional candidates may be selected.

37. The method of claim 35 wherein the maximum number is one.

38. The method of claim 35 wherein the maximum number is greater than one.

39. A method in a computing system for completing a blank ballot, comprising:
displaying a list of two or more candidates;
receiving first user input selecting a first one of the candidates;
in response to receiving the first user input, displaying an indication that the first candidate is selected;
after receiving the first user input, receiving second user input selecting a second one of the candidates; and
in response to receiving the second user input, displaying a warning indicating that the selection of the first candidate is being changed to the selection of a second candidate.

40. A method in a computing system for casting a ballot, comprising:
receiving user input selecting one candidate in each of a plurality of races;
simultaneously displaying (a) an indication of each candidate selected by the user input, and (b) a control for approving the selections; and
casting the ballot only in response to operation of the control for approving the selections.

41. The method of claim 40, further comprising:
displaying a control for modifying the selections; and
if the control for modifying the selections is operated, enabling the user to provide additional user input modifying the selection of the candidates.

42. A method for facilitating voting by a voter, comprising:
at a registration station:
verifying the voter's identity;
if the voter's identity as verified qualifies the voter to vote, providing to the voter a portable memory device connoting the voter's individuated right to vote;
at a voting station:
accessing the portable memory device to discern the voter's individuated right to vote;
enabling the voter to select one of a plurality of candidates in each of one or more election races; and
producing for the voter a physical receipt evidencing the voter's voting.

43. A method in a computing system for storing in a storage device records containing information derived from voted election ballots, comprising:
receiving a plurality of records, each record containing information derived from one of a plurality of voted election ballots; and
for each received record:
selecting a random location in the storage device at which to store the record using a hardware random-number generator; and
storing the record at the selected random location, thus dissociating the positions of the records in the storage device from the order in which the records are received.

44. The method of claim 43 wherein the records are stored on a magnetic medium.

45. The method of claim 43 wherein the records are stored on a hard drive.

46. The method of claim 43 wherein the records are stored on a removable medium.

47. The method of claim 43 wherein the records are stored in programmable read-only memory.

48. The method of claim 43 wherein the records are stored in random access memory.

49. The method of claim 43 wherein the records are stored in a database.

50. The method of claim 43, further comprising splitting each received record into a first portion and a second portion, and wherein the first portion of each record is stored in a database, and wherein the first portion of each record is stored in a file system file.

51. The method of claim 43, further comprising selecting the randomly-selected location using a random-number generator.

52. A computer memory containing a sequential series of entries, each entry capable of containing a record of the voting of a single voter among a plurality of voters, a record of the voting of each voter of the plurality being stored in a randomly-selected entry in the series of entries,
such that records of the voting of particular voters may not be identified based upon the locations of the entries containing the records of the voting.

53. A method in a computing system for tracking a voted ballot during processing, comprising:
receiving the voted ballot, the received voted ballot being encoded, then encrypted, then signed with a private key generated for the voter voting the voted ballot;
separating the signature from the encoded and encrypted voted ballot;
identifying the signature and the encoded and encrypted voted ballot without signature in such a way that an association is maintained between the signature and the encoded and encrypted voted ballot without signature;
decrypting the encoded and encrypted voted ballot without signature;
identifying the encoded and decrypted voted ballot in such a way that an association is maintained between the signature and the encoded and decrypted voted ballot;
decoding the encoded and decrypted voted ballot;
identifying the decoded voted ballot in such a way that an association is maintained between the signature and the decoded voted ballot,
such that the signature of the received voted ballot may be accessed based on the identification of the decoded voted ballot to correlate the decoded voted ballot with the voter voting the voted ballot, using a public key generated for the voter voting the voted ballot.

54. A computer-readable medium whose contents cause a computing system to track a voted ballot during processing, comprising:
receiving the voted ballot, the received voted ballot being encoded, then signed with a private key generated for the voter voting the voted ballot;
separating the signature from the encoded voted ballot;
identifying the signature and the encoded voted ballot without signature in such a way that an association is maintained between the signature and the encoded voted ballot without signature;
decoding the encoded voted ballot without signature;
identifying the decoded voted ballot in such a way that an association is maintained between the signature and the decoded voted ballot,
such that the signature of the received voted ballot may be accessed based on the identification of the decoded voted ballot to identify the sanctioned election worker signing the voted ballot to correlate the decoded voted ballot with the voter voting the voted ballot, using a public key generated for the voter voting the voted ballot.

55. A method in a computing system for determining election results, comprising:
receiving a plurality of cast ballots, each cast ballot having a certification provided by a particular election official connoting the approval of the voter casting the ballot; and
for each received cast ballot, counting the cast ballot only if the certification of the cast ballot can be uninterruptedly traced back to an election official who is the ultimate certification authority for voter approval.

56. The method of claim 55 wherein each received cast ballot designates, for each of a plurality of election races, up to one voted-for candidate, and wherein counting a cast ballot includes incrementing a total of votes cast for each candidate designated by the cast ballot as voted-for.

57. The method of claim 55 wherein each election official providing a certification of a cast ballot has a private encryption key, the method further comprising certifying each cast ballot by signing a public key of the voter casting the cast ballot with a private key of the election official providing a certification of the cast ballot.

58. The method of claim 55 wherein electronic cast ballots are received.

59. A method in a computing system for determining election results, comprising:
receiving a plurality of cast ballots, each cast ballot having a certification connoting the approval of the cast ballot by the voter casting the ballot; and
for each received cast ballot, counting the cast ballot only if the certification of the cast ballot is among a set of certifications issued to voters by an election authority.

60. The method of 59, further comprising determining whether the certification of the ballot is among a set of certifications issued to voters by an election authority by determining if the cast ballot is signed by a private key corresponding any of a set of public keys each corresponding to a private key issued to a voter to connote the voter's eligibility to vote.

61. The method of 59, further comprising determining whether the certification of the cast ballot is among a set of certifications issued to voters by an election authority by:
determining if the cast ballot is signed by a private key corresponding any of a set of public keys each corresponding to a private key issued to a voter to connote the voter's eligibility to vote; and
determining whether a public key corresponding the private key with which the cast ballot is signed has been signed with the private key of an authorized election official.

62. The method of claim 59 wherein each received cast ballot designates, for each of a plurality of election races, up to one voted-for candidate, and wherein counting a ballot includes incrementing a total of votes cast for each candidate designated by the ballot as voted-for.

63. A method of determining whether a ballot style is proper to use in an election, comprising:
accessing a ballot style authorization policy established for the election, the authorization policy referencing an authority structure established for the election;
accessing a record of an authorization process performed for the ballot style, the record of the authorization process referencing the authority structure; and
determining that the ballot style is proper to use in the election only if the record of an authorization process indicates that the authorization process was performed in accordance with the authorization policy.

64. The method of claim 63 wherein the authority structure established for the election is a public key infrastructure.

65. The method of claim 63 wherein the accessed record of an authorization process performed for the ballot style is attached to the ballot style.

66. The method of claim 63 wherein the accessed record of an authorization process performed for the ballot style is one or more cryptographic signatures of the ballot style.

67. A method for conducting an election, comprising:
establishing a public key infrastructure for use in an election; and
employing the established public key infrastructure in the operation of a voting site.

68. The method of claim 67 wherein the established public key infrastructure is employed in the operation of a physical voting site.

69. The method of claim 67 wherein the established public key infrastructure is employed in the operation of a virtual voting site.

70. The method of claim 67 wherein the public key infrastructure includes an authority tree for authorizing voters to vote in the election.

71. The method of claim 70 wherein the root of the authority tree is an entity with ultimate responsibility for voter authorization.

72. The method of claim 70 wherein the root of the authority tree is an individual with ultimate responsibility for voter authorization.

73. The method of claim 70 wherein the root of the authority tree is a group with ultimate responsibility for voter authorization.

74. The method of claim 70 wherein the leafs of the authority tree are authorized voters.

75. The method of claim 70 wherein the parents of leafs in the authority tree are election workers who directly authorize voters.

76. The method of claim 70 wherein the non-root ancestors of the parents of leafs in the authority tree are intermediary election officials.

77. The method of claim 70, further comprising, for each non-root node of the authority tree, storing a public key of the node, signed by a private key of the parent of the node, such that, for an authorized voter, there is stored a public key of the authorized voter signed by an election worker, a public key of the election worker's signed by a descendent of an ultimate authority for voter authorization, and, for nodes in a path between the ultimate authority and the descendent of the ultimate authority, a public key of the child node signed with a private key of the parent node.

78. The method of claim 67 wherein the public key infrastructure includes an authority tree for approving a ballot style for the election.

79. The method of claim 78, further comprising using the authority tree to approve a ballot style for the election in accordance with an approval policy established for the election.

80. The method of claim 79, further comprising storing details of the approval process.

81. The method of claim 80, further comprising auditing the authorization of a ballot style by using the stored details to determine whether the authority tree was used to approve a ballot style for the election in accordance with the approval policy.

82. The method of claim 79 wherein the approval policy requires that the ballot style be signed by at least a minimum number of nodes in the authority tree having a particular quality.

83. A method in a computing system for casting a ballot, comprising:
storing data including a reference to a public key generated for a voter; and
signing data representing a ballot voted by the voter with a private key generated for the voter.

84. The method of claim 83 wherein the data including a reference to the public key generated for the voter that is stored is signed with a private key of a poll worker identifying the voter as eligible to vote, thus demonstrating that the voter is an eligible voter.

85. The method of claim 83 wherein the reference to the public key generated for the voter included in the stored data is a copy of the public key generated for the voter.

86. The method of claim 83 wherein the reference to the public key generated for the voter included in the stored data is a pointer to the public key generated for the voter.

87. The method of claim 83 wherein the reference to the public key generated for the voter included in the stored data is an identifier associated with the public key generated for the voter.

88. The method of claim 83 wherein the reference to the public key generated for the voter included in the stored data is an index to the public key generated for the voter.

89. The method of claim 83, further comprising applying the public key generated for the voter to the signed ballot to demonstrate that the private key was used to sign the data representing the voted ballot, and thus that the voted ballot represented by the signed data was cast by the voter.

90. The method of claim 83, further comprising applying the public key generated for the voter to the signed voted ballot to demonstrate at a time after the data representing the voted ballot is signed that the data representing the voted ballot is identical to the data representing the voted ballot at the time it was signed, and was not modified in the interim.

91. The method of claim 83, further comprising generating the public key and the private key for the voter.

92. The method of claim 91 wherein the public key and the private key are generated in response to a command issued by a poll worker identifying the voter as eligible to vote, but the private key is inaccessible to the poll worker.

93. The method of claim 83 wherein the public key and the private key are generated by the voter, further comprising receiving the public key from the voter.
